(19) United States
(12) Patent Application Publication
(10) Pub. No.: US 2008/0118625 A1
(43) Pub. Date: May 22, 2008

(54) EXTRUDED BEAN SNACKS AND BEAN PORRIDGE

(75) Inventors: Kirk Dolan, East Lansing, MI (US); George Nyombaire, East Lansing, MI (US); Maurice Bennink, Holt, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: THE BOARD OF TRUSTEES OPERATING, East Lansing, MI (US)

(21) Appl. No.: 11/934,466

(22) Filed: Nov. 2, 2007

Related U.S. Application Data
(60) Provisional application No. 60/863,990, filed on Nov. 2, 2006.

(51) Int. Cl. A23P 1/12; A23L 1/20; A23L 1/10; A23L 1/36

(52) U.S. Cl. 426/618; 426/516; 426/634; 426/629

(57) ABSTRACT

A very low cost extruder system was tested for the inactivation of phytohemagglutinins in beans, such as but not limited to cranberry beans. Cranberry beans were extruded at either 105 or 130° C. (die end). The screw speed was 118, 194 or 255 revolutions per minute (rpm). The feed rate was set at either 85 or 120 g/min and moisture content was set at either 25 or 35%. The phytohemagglutinin activity in the extruded samples was determined in triplicate by Enzyme-Linked Immunosorbent Assay (ELISA). The very low cost extruder system inactivated active phytohemagglutinins in the extruded cranberry beans by over 98%.

### CROSS-REFERENCE TO RELATED APPLICATION

The instant application claims priority to U.S. Provisional Patent Application Ser. No. 60/863,990, filed Nov. 2, 2006, the entire specification of which is expressly incorporated herein by reference.

### BACKGROUND OF THE INVENTION

1. Field of the Invention

The present invention generally relates to systems for processing beans and more specifically to a very low cost extruder system that is operable to produce beans snacks and bean porridge suitable for human consumption.

2. Description of the Related Art

A significant part of the world relies on dry beans (e.g., Phaseolus vulgaris L.) as a staple food for subsistence, particularly in combination with cereals. Beans are relatively high-protein/low-fat foods, and may have cancer preventative properties, e.g., as compared to typical wheat and corn snacks or porridge. However, beans contain phytohemagglutinins, protease inhibitors and amylase inhibitors. These “anti-nutrients” should be inactivated, the starch should be gelatinized, and the beans should be ground or softened before human consumption. One method of reducing the activity of these anti-nutrients is through high-temperature cooking in an autoclave. However, this method is very expensive and energy-intensive

Another method is extrusion. However, conventional extrusion equipment is not well-suited to use in countries with low per capita income, as extrusion equipment typically requires a considerable financial investment.

Accordingly, there exists a need for an inexpensive extruder system operable to inactivate phytohemagglutinin activity in various beans, including but not limited to cranberry beans, wherein materials suitable for human consumption, such as but not limited to snacks, flour and/or porridge, can be produced therefrom.

### SUMMARY OF THE INVENTION AND ADVANTAGES

In accordance with the general teachings of the present invention, there is provided an inexpensive extruder system operable to inactivate phytohemagglutinin activity in various beans, including but not limited to cranberry beans, wherein materials suitable for human consumption, such as but not limited to snacks, flour and/or porridge, can be produced therefrom.

By way of a non-limiting example, the extruder system was tested for the inactivation of phytohemagglutinins in beans, such as but not limited to cranberry beans. Cranberry beans were extruded at either 105 or 130° C. (die end). The screw speed was set at 118, 194 or 255 revolutions per minute (rpm). The feed rate was set at either 85 or 120 g/min, and moisture content was set at either 25 or 35%. The phytohemagglutinin activity in the extruded samples was determined in triplicate by Enzyme-Linked Immunosorbent Assay (ELISA). It was determined that the extruder system of the present invention inactivated active phytohemagglutinins in the extruded cranberry beans by over 98%.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a graphical view of the effect of screw speed on phytohemagglutinin activity in the dried bean extrudate produced in accordance with the general teachings of the present invention;

FIG. 2 is a graphical view of the effect of moisture content on phytohemagglutinin activity in the dried bean extrudate produced in accordance with the general teachings of the present invention; and

FIG. 3 is a graphical view of the effect of feed rate on phytohemagglutinin activity in the dried bean extrudate produced in accordance with the general teachings of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

Dry cranberry beans (Phaseolus vulgaris L.) were purchased from Bayside Best Beans, LLC (Sebewiang, Mich.). The damaged beans were segregated from the main population, and then the raw bean material was ground using a hammer mill (Model D Comminuting Machine, The W. J. Fitzpatrick Company, Chicago, Ill.).

Extrusion of the raw ground cranberry beans was accomplished using a low cost laboratory co-rotating twin-screw extruder model JS30A manufactured in Yantai, China by Qitong Chemical Industry Equipment Co, Ltd. The screws were 30 mm in diameter and the barrel had a length/diameter (L/D) ratio of 16. The cranberry bean flour was extruded at 25% and 39% moisture content (wet basis), although percentages outside of these ranges can also be used in the present invention, such as but not limited to 20-40% moisture content (wet basis). The screw speed was set at 118, 194 and 255 revolutions per minute (rpm), although screw speeds outside of these ranges can also be used in the present invention. The feed rate was set at either 85 or 120 g/min, although feed rates outside of these ranges can also be used in the present invention. Extrusion barrel temperature was set at either 105 or 130° C. (die end), although temperatures outside of these ranges can also be used in the present invention, such as but not limited to 100-130° C.

The bean extrudates were dried overnight at 60° C. and then ground to pass through a 0.5 mm sieve. Phytohemagglutinin activity in the extruded samples was determined in triplicate by enzyme-linked immunosorbent assay (ELISA). A statistical software program, JMP IN 5.1 (SAS Institute, Inc., Cary, N.C.), was used for data analysis.

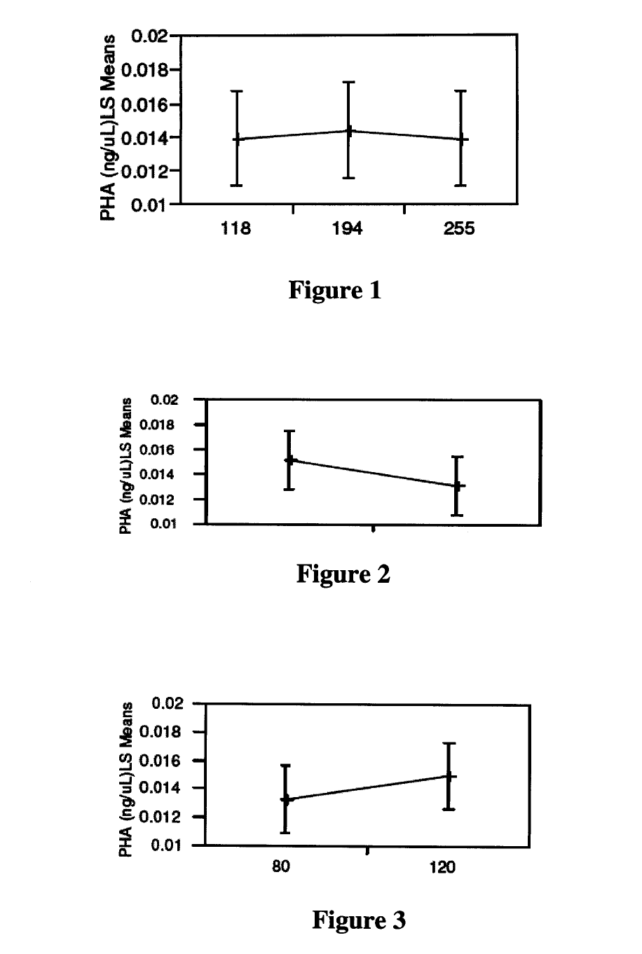

The results indicated that the very low cost extruder system inactivated active phytohemagglutinins in the extruded cranberry beans by over 98% (e.g., see the Table below). Feed rate, moisture content and screw speed, however, did not show a significant difference (p=0.05) for the inactivation of phytohemagglutinins (e.g., see FIGS. 1-3).

TABLE
Raw beans = 1.228 ng/UI [PHYTOHEMMAGGLUTINS?]

| Feed Rate | Moisture | Screw | PHA | % reduction |
|---|---|---|---|---|
| (g/min) | Content (%) | speed (rpm) | (ng/μL) | of PHA |
| 80 | 25 | 118 | 0.015 | 98.8 |
| 80 | 25 | 194 | 0.013 | 98.9 |
| 80 | 25 | 255 | 0.017 | 98.6 |
| 80 | 39 | 118 | 0.012 | 99.0 |
| 80 | 39 | 194 | 0.011 | 99.1 |
| 80 | 39 | 255 | 0.012 | 99.0 |
| 120 | 25 | 118 | 0.014 | 98.9 |
| 120 | 25 | 194 | 0.016 | 98.7 |
| 120 | 25 | 255 | 0.016 | 98.7 |
| 120 | 39 | 118 | 0.015 | 98.8 |
| 120 | 39 | 194 | 0.018 | 98.5 |
| 120 | 39 | 255 | 0.011 | 99.1 |

Accordingly, the very low cost extruder systems of the present invention, such as those produced in developing countries or newly emerging industrial countries, can be used by both developed and developing countries in the production of safe and low cost nutritional bean products such as but not limited to infant flours, bean snacks, bean porridge, and/or the like. For example, a bean snack product can be produced with any number/types of flavoring agents, such as but not limited to salt, barbeque, sugar, cheese, chocolate, garlic, peanut, almond, other nuts, cinnamon, and other spices. The flavorings can be added to the raw bean flour before processing, or alternatively, the flavorings could be sprayed on after the extruding step. Thus, a safe, healthy, nutritious, shelf-stable, high-protein snacks produced from beans can be manufactured by using a very low cost extruder system, as previously described.

It should be noted that in order to produce bean porridge and/or bean flours, the dried bean extrudate would merely have to be further milled to a finer consistency, such as those associated with a flour and/or porridge material. For example, to produce flour, the raw beans would be ground, e.g., in a hammer mill. The extrudates for producing porridge would typically be ground to a 40-80 mesh size. Of course, the flour and/or porridge would typically be mixed with water or other materials (e.g., milk, oil, butter, and/or the like) before consumption.

Additionally, the bean products of the present invention can be used a partial replacement for other protein sources, such as but not limited to materials such as but not limited to texturized vegetable protein (e.g., TVP®).

It should also be noted that the present invention can be practiced with many different types of beans and/or legumes, such as but not limited to cranberry beans, red kidney beans, and/or the like. Additionally, the beans can be mixed with other foodstuffs, e.g., corn or other grains and/or cereals, either before or after extrusion, so as to produce a complete and/or more complete protein foodstuff.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for reducing the level of phytohemagglutinins in foodstuffs, comprising:
providing a foodstuff having a first level of phytohemagglutinins; and
subjecting the foodstuff to an extrusion process to form an extrudate;
the extrudate having a second level of phytohemagglutinins after the extrusion process;
the second level being less than the first level.

2. The invention according to claim 1, wherein the extrusion process causes a reduction in the level phytohemagglutinins in the extrudate.

3. The invention according to claim 1, wherein the extrusion process occurs at a temperature sufficient to cause a reduction in the level phytohemagglutinins in the extrudate.

4. The invention according to claim 3, wherein the temperature is in a range of 100-130° C.

5. The invention according to claim 1, further subjecting the extrudate to a grinding process.

6. The invention according to claim 5, wherein substantially all of the ground extrudate is able to pass through a 0.5 mm sieve.

7. The invention according to claim 5, wherein the grinding process causes a reduction in the level phytohemagglutinins in the ground extrudate.

8. The invention according to claim 5, wherein substantially all of the ground extrudate is able to pass through a 40-80 mesh size screen.

9. The invention according to claim 1, wherein the second level is about 98% less than the first level.

10. The invention according to claim 1, wherein the foodstuff is selected from the group consisting of beans, legumes, grains, cereals, and combinations thereof.

11. The invention according to claim 1, further comprising a flavoring agent added to either the foodstuff or extrudate.

12. The invention according to claim 1, further comprising a flavoring agent added to the ground extrudate.

13. A method for reducing the level of phytohemagglutinins in foodstuffs, comprising:
providing a foodstuff having a first level of phytohemagglutinins; and
subjecting the foodstuff to an extrusion process operating at a temperature in a range of 100-130° C. to form an extrudate;
the extrudate having a second level of phytohemagglutinins after the extrusion process;
the second level being less than the first level.

14. The invention according to claim 13, wherein the extrusion process causes a reduction in the level phytohemagglutinins in the extrudate.

15. The invention according to claim 13, wherein the extrusion process occurs at a temperature sufficient to cause a reduction in the level phytohemagglutinins in the extrudate.

16. The invention according to claim 13, further subjecting the extrudate to a grinding process, wherein substantially all of the ground extrudate is able to pass through a 0.5 mm sieve or a 40-80 mesh size screen.

17. The invention according to claim 16, wherein the grinding process causes a reduction in the level phytohemagglutinins in the ground extrudate.

18. The invention according to claim 13, wherein the second level is about 98% less than the first level.

19. The invention according to claim 13, wherein the foodstuff is selected from the group consisting of beans, legumes, grains, cereals, and combinations thereof.

20. The invention according to claim 13, further comprising a flavoring agent added to either the foodstuff or extrudate.

21. The invention according to claim 16, further comprising a flavoring agent added to the ground extrudate.

22. A method for reducing the level of phytohemagglutinins in foodstuffs, comprising:
providing a foodstuff having a first level of phytohemagglutinins, the foodstuff being selected from the group consisting of beans, legumes, grains, cereals, and combinations thereof;
subjecting the foodstuff to an extrusion process operating at a temperature in a range of 100-130° C. to form an extrudate, wherein the extrusion process causes a reduction in the level phytohemagglutinins in the extrudate; and
subjecting the extrudate to a grinding process, wherein substantially all of the ground extrudate is able to pass through a 0.5 mm sieve or a 40-80 mesh size screen, wherein the grinding process causes a reduction in the level phytohemagglutinins in the ground extrudate;
the ground extrudate having a second level of phytohemagglutinins after the extrusion process;
the second level being less than the first level.

23. The invention according to claim 22, wherein the second level is about 98% less than the first level.

24. The invention according to claim 22, further comprising a flavoring agent added to the foodstuff, extrudate, or ground extrudate.
